(19) United States
(12) Patent Application Publication
(10) Pub. No.: US 2004/0122800 A1
(43) Pub. Date: Jun. 24, 2004

(54) Method and apparatus for hardware assisted control redirection of original computer code to transformed code

(76) Inventors: Sreekumar R. Nair, Sunnyvale, CA (US); Santosh G. Abraham, Pleasanton, CA (US)

Correspondence Address: PARK, VAUGHAN & FLEMING LLP, 508 SECOND STREET, SUITE 201, DAVIS, CA, 95616, US

(21) Appl. No.: 10/329,009

(22) Filed: Dec. 23, 2002

(51) Int. Cl. G06F 17/30

(52) U.S. Cl. 707/2

(57) ABSTRACT

One embodiment of the present invention provides a system that redirects control flow of original code to transformed code. The system includes a computer processor with an instruction fetch unit that determines a next instruction to be executed by the processor. The system also includes a control redirection buffer, which indicates whether to conditionally redirect execution from a first instruction address to a second instruction address so that the transformed code at the second instruction address can be executed in place of the original code at the first instruction address.

### BACKGROUND

1. Field of the Invention

The present invention relates to the design of processors for computer systems. More specifically, the present invention relates to an apparatus and a method for redirecting control flow of original computer code to transformed code.

2. Related Art

Modern compilers are able to perform aggressive optimizations based on static profile feedback. This feedback gives the compiler a feel for which regions of a program that are most frequently executed. However, as programs continue to grow in complexity, static profile feedback may not provide information representative of the actual program execution.

One solution to this problem is to use a dynamic binary optimizer (runtime optimizer) to perform profiling and optimization while the program is executing. Runtime optimizations can exploit many situations that are typically difficult to optimize in a static compiler. For example, these situations can include:

optimizing whole programs including shared libraries and kernels;

optimizing programs with phase shifts;

optimizing dynamically changing program traces;

optimizing legacy code for newer pipeline architectures; and

optimizing dynamically generated code as in the case of a JAVA™ virtual machine.

Thus, runtime optimizers help bridge the gap that currently exists between static compilers and the execution time behavior of a program, which is crucial for building competitive computing platforms. (JAVA is a trademark of SUN Microsystems, Inc.)

Runtime optimizers are just one of a wide category of applications collectively referred to as dynamic code transformers (DCTs). DCTs play an important role in performance monitoring, analysis, and optimization of running programs. DCTs include, but are not limited to: dynamic translators, dynamic profilers, dynamic debuggers, dynamic instrumentation handlers, and the like.

There are many problems associated with using DCTs. For example:

many computer architectures require dynamically transformed code to be placed within a short range, say ±128 KB, of the current program counter;

many executing programs cannot be modified because of internal security measures such as checksums;

modifying code within a running program may be prohibited by the operating system of the computer;

changes to executing code should be made atomically to prevent erroneous results during the changeover; and

changes to executing code should be made in a manner that is persistent across context switches.

Attempts have been made to address these problems. For example the system disclosed in U.S. Pat. No. 6,185,669 B1 to Hsu et al. (Hsu) provides a cache table for mapping branch targets. While effective in some instances, the system of Hsu has several drawbacks. These drawbacks include:

limited size of the cache table which limits redirection capability;

redirection is unconditional;

redirection can be lost during a context switch; and

dynamic code transformations are not secure.

Hence, what is needed is a method and an apparatus that provides control redirection to facilitate the use of dynamic code transformers without the problems listed above.

### SUMMARY

One embodiment of the present invention provides a system that redirects control flow of original code to transformed code. The system includes a computer processor with an instruction fetch unit (IFU) that determines the next instruction to be executed by the processor. The system also includes a control redirection buffer, which indicates whether to conditionally redirect execution from a first instruction address to a second instruction address so that the transformed code at the second instruction address can be executed in place of the original code at the first instruction address.

In a variation of this embodiment, the system includes a control redirection table in main memory that stores control redirection buffer entries for each page of instructions in the original code.

In a further variation, the system includes an instruction translation look-aside buffer (ITLB), wherein each entry in the ITLB indicates whether an associated page of instructions includes entries in the control redirection table.

In a further variation, each entry in the ITLB indicates whether all entries for a given page in the control redirection table have been entered in the control redirection buffer.

In a further variation, the IFU examines the ITLB and the control redirection buffer in parallel to determine whether to redirect the next instruction.

In a further variation, each entry in the control redirection buffer includes a condition field, which indicates that the redirection is conditional upon a specific event taking place during execution of the original code.

In a variation of this embodiment, the transformed code can include: code that is optimized to improve performance, code that is instrumented for profiling, and code that is transformed to facilitate debugging.

In a variation of this embodiment, redirection to the transformed code is accomplished without modifying the original code.

In a variation of this embodiment, redirections are persistent across context switches.

### BRIEF DESCRIPTION OF THE FIGURES

FIG. 1 illustrates a computer system 100 in accordance with an embodiment of the present invention.

FIG. 2 illustrates the structure of a control redirection buffer or a control redirection table in accordance with an embodiment of the present invention.

FIG. 3 is a flowchart illustrating the process of determining whether to redirect instruction execution in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Computing System

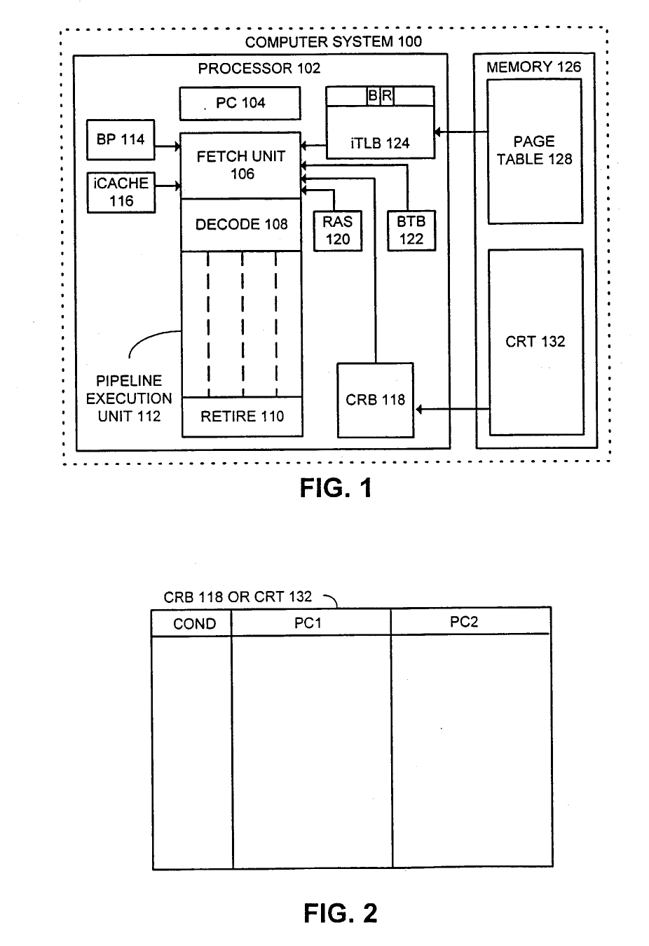

FIG. 1 illustrates a computer system 100 in accordance with an embodiment of the present invention. Computer system 100 can generally include any type of computer system, including, but not limited to, a computer system based on a microprocessor, a mainframe computer, a digital signal processor, a portable computing device, a personal organizer, a device controller, and a computational engine within an appliance. As is illustrated in FIG. 1, computer system 100 includes processor 102 and memory 126.

Processor 102 includes program counter 104, pipeline execution unit 112, branch predictor 114, instruction cache 116, instruction translation look-aside buffer 124, return address stack 120, branch target buffer 122, and control redirection buffer 118. Moreover, pipeline execution unit 112 includes fetch unit 106, decode 108, retire 110, and other units (not shown) that are typical of a pipeline execution unit. Pipeline execution units are well-known in the art. Hence, the operation of pipeline execution unit 112 (other than fetch unit 106) will not be described further herein. The operation of fetch unit 106 is described in more detail below.

The value in program counter 104 determines which instruction processor 102 will execute next. Typically, instructions are executed sequentially by incrementing program counter 104. However, certain instructions such as branch instructions load a new address into program counter 104 and execution then continues from the instruction at the new address.

Fetch unit 106 determines which instruction will be executed next based upon inputs from a number of units, including branch predictor 114, instruction cache 116, instruction translation look-aside buffer 124, return address stack 120, branch target buffer 122, and control redirection buffer 118. These units are well known in the art and will not be described further herein.

Instruction translation look-aside buffer 124 caches standard page table entries that include two additional bits labeled “B” and “R” for controlling redirection.

Control redirection buffer 118 caches a number of entries, wherein each entry includes a source address (PC1), a target address (PC2), and optionally, a condition code, which indicates that the redirection is conditional upon a specific event taking place during execution of the original code. For example, the redirection can be conditional upon a large number of load misses occurring in the original code.

Memory 126 contains page table 128 and control redirection table 132. Page tables are well known in the art and will not be described further detail. Control redirection table 128 stores control redirection buffer entries for each page of instructions in the original code. These control redirection buffer entries are loaded into control redirection buffer 118 as they are needed.

During operation, fetch unit 106 receives a current instruction address. This current instruction address is compared with each source address (PC1) in control redirection buffer 118 to find a match. If a match is located, program counter 104 is loaded with the corresponding target address PC2, thereby redirecting execution of the program to the transformed code. Note that if there is a condition associated with the matching entry in control redirection buffer 118, redirection will occur only if the condition is met.

If no match is found in control redirection buffer 118, fetch unit 106 examines bits in a corresponding entry in instruction translation look-aside buffer 124. If the “B” bit in this entry is not set, there are no redirections on the current page of instructions. Hence, no redirection takes place and the next instruction address is loaded into program counter 104.

If the “B” bit is set, there are redirections in the current page of instructions. In this case the “R” bit is examined. If the “R” bit is set, all of the redirections for the current page of instructions have been loaded into control redirection buffer 118. Since no match was found in control redirection buffer 118, there is no redirection for the current address.

If, however, the “R” bit is not set, redirections for the current page have not all been loaded from control redirection table 132 into control redirection buffer 118. In this case, the system loads as many redirection entries into control redirection buffer 118 as possible by way of a trap into the operating system. Fetch unit 106 then examines the entries in control redirection buffer 118 and any entries that cannot be loaded for a match. If a match is found, control is redirected as describe above. Otherwise, the program continues execution as normal.

Operation of a Dynamic Code Transformer

When a DCT, for example a runtime optimizer, determines that a given section of code should be replaced by transformed code, the DCT creates an entry in control redirection table 132. This entry includes the beginning address PC1 of the given section of code as well as the beginning address PC2 of the transformed code. The DCT can also set a condition code in the entry so that the transformed code will be executed only if the condition is met.

Additionally, the DCT sets the “B” bit for the appropriate page in page table 128 to indicate that redirections exist in the page. Thus, when the page is subsequently loaded for execution, corresponding entries from control redirection table 132 will be loaded into control redirection buffer 118 as described above. This causes the transformed code to be executed in place of the original code.

The DCT requests the operating system to purge the modified page table entries from all TLBs in the system. The operating system typically issues a cross-processor interrupt to all the processors that may have the modified page table entry in their TLB. The processors remove these page table entries for their TLBs and send an acknowledgement back. At this point, the DCT can be sure that the redirections installed will take effect on all processors in the system. Note that no changes are made to the original code during this process.

Control Redirection Data Structures

FIG. 2 illustrates the structure of both control redirection buffer 118 and control redirection table 132 in accordance with an embodiment of the present invention. Note that control redirection buffer 118 and control redirection table 132 contain the same type of entries but they differ in size. Control redirection table 132 is located in memory and includes entries for all redirections in the executing system, whereas control redirection buffer 118 contains entries associated with instructions that are currently executing.

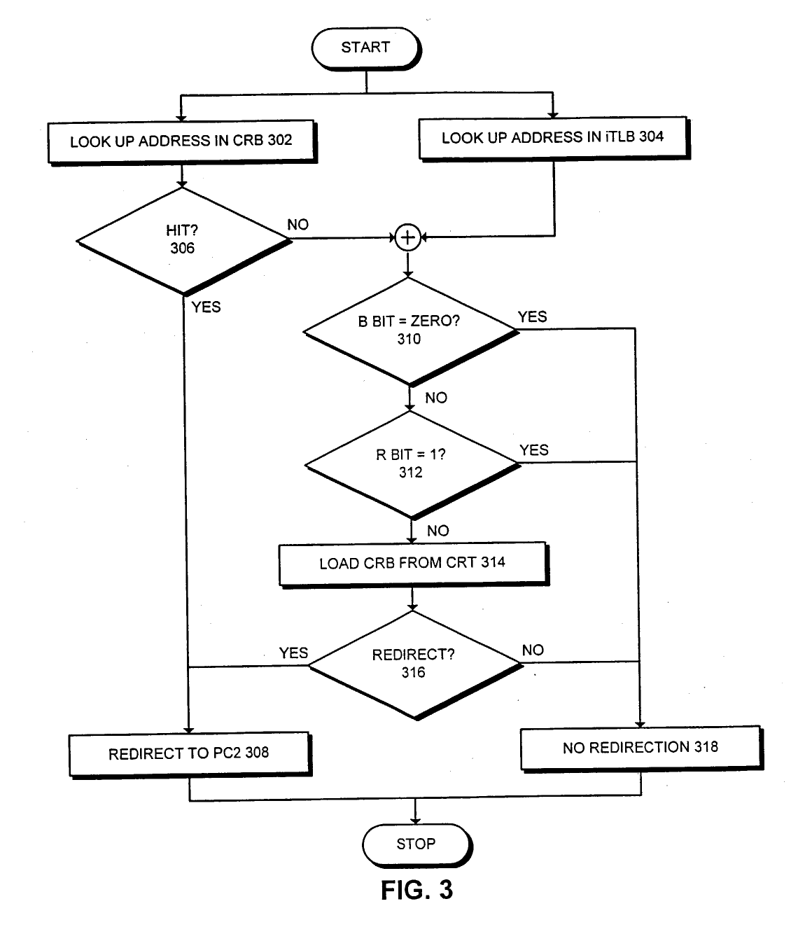

During operation, when a page of instructions with the “B” bit set is loaded, the related entries within control redirection table 132 are loaded into control redirection buffer 118 within processor 102. If all of the related entries for this page are loaded into control redirection buffer 118, the “R” bit is set. This process is described in more detail in conjunction with FIG. 3 below.

Redirecting Instruction Execution

FIG. 3 is a flowchart illustrating the process of redirecting execution in accordance with an embodiment of the present invention. The system starts by looking up a current instruction address from program counter 104 in control redirection buffer 118 (step 302). Simultaneously, the system looks up the current instruction address in the instruction translation look-aside buffer 124 (step 304). The system next determines if there is a “hit” within control redirection buffer 118, which means that an entry for the address is found within control redirection buffer 118 (step 306). If there is a hit, execution is redirected to PC2, which contains the start address of the transformed code (step 308).

If the current instruction address is not found within control redirection buffer 118, which means that there is no hit at step 306, the system determines if the “B” bit is set (step 310). If the “B” bit is not set, there is no redirection (step 318).

On the other hand, if the “B” bit is set, the system next determines if the “R” bit is set (step 312). If the “R” bit is set, all redirections for the current page of instructions have been loaded into control redirection buffer 118 from control redirection table 132. Since no hit occurred in control redirection buffer 118 at step 306, there is no redirection (step 318).

If the “R” bit is not set at step 312, the system loads control redirection buffer 118 from control redirection table 132 (step 314). Additionally, if all of the relevant entries for the current page are loaded from control redirection table 132 into control redirection buffer 118, the system sets the “R” bit for that page. Next, the system examines the entries in control redirection buffer 118, and if necessary, examines the remaining entries in control redirection table 132 to determine if the current instruction address is subject to redirection (step 316). If so, control is passed to step 308, otherwise no redirection takes place (step 318).

If control is to be redirected, program counter 104 is loaded with PC2 to effect the redirection and execution of the transformed code (step 308). If control is not to be redirected, program counter 104 is loaded with the value from the original code and execution continues with no redirection (step 318).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for redirecting control flow of an original code to a transformed code, comprising:
a computer processor;
an instruction fetch unit within the computer processor, wherein the instruction fetch unit determines a next instruction to be accessed by the computer processor; and
a control redirection buffer, wherein the control redirection buffer indicates a redirection from a first instruction address to a second instruction address;
whereby the transformed code at the second instruction address can be executed in place of the original code at the first instruction address.

2. The apparatus of claim 1, further comprising a control redirection table in main memory that stores control redirection buffer entries for each page of instructions in the original code.

3. The apparatus of claim 2, further comprising an instruction translation look-aside buffer, wherein each entry in the instruction translation look-aside buffer indicates whether an associated page of instruction includes entries in the control redirection table.

4. The apparatus of claim 3, wherein each entry in the instruction translation look-aside buffer indicates whether all entries for a given page in the control redirection table have been entered in the control redirection buffer.

5. The apparatus of claim 3, wherein the instruction fetch unit examines the instruction translation look-aside buffer and the control redirection buffer in parallel to determine whether to redirect the next instruction.

6. The apparatus of claim 3, wherein each entry in the control redirection buffer includes a condition field, which indicates that the redirection is conditional upon a specific event taking place during execution of the original code.

7. The apparatus of claim 1, wherein the transformed code can include:
code that is optimized to improve performance;
code that is instrumented for profiling; and
code that is transformed to facilitate debugging.

8. The apparatus of claim 1, wherein redirection to the transformed code is accomplished without modifying the original code.

9. The apparatus of claim 1, wherein redirections are persistent across context switches.

10. A method for redirecting control flow of an original code to a transformed code, comprising:
determining an instruction address for an instruction in the original code;
comparing the instruction address with addresses located in a first address column within a control redirection buffer; and
if the instruction address matches an address within the first address column, loading a second address associated with the address from the first address column into a program counter;
whereby the transformed code at the second address can be executed in place of the original code at the instruction address.

11. The method of claim 10,
wherein comparing the instruction address with addresses located in the first address column further comprises evaluating a condition associated with the address within the first address column; and
loading the second address into the program counter only if the condition is true.

12. The method of claim 10, further comprising examining a page buffer for the instruction address, wherein the page buffer includes a first bit and a second bit that provide information about redirecting the instruction to alternative code.

13. The method of claim 12, wherein the first bit indicates whether an associated page of the first bit includes entries in a control redirection table.

14. The method of claim 13, wherein the second bit indicates whether all entries in an associated control redirection table have been loaded into the control redirection buffer.

15. The method of claim 10, wherein redirection to a modified instruction code sequence is accomplished without modifying an original instruction code sequence.

16. The method of claim 10, further comprising a control redirection table within a memory, wherein the control redirection table includes a list of address translations for a given page of instructions.

17. The method of claim 10, wherein redirections are persistent across context switches.

18. A computer system for redirecting control flow of an original code to a transformed code, comprising:
a computer processor;
an instruction fetch unit within the computer processor, wherein the instruction fetch unit determines a next instruction to be accessed by the computer processor; and
a control redirection buffer, wherein the control redirection buffer indicates a redirection from a first instruction address to a second instruction address;
whereby the transformed code at the second instruction address can be executed in place of the original code at the first instruction address.

19. The computer system of claim 18, further comprising a control redirection table in main memory that stores control redirection buffer entries for each page of instructions in the original code.

20. The computer system of claim 19, further comprising an instruction translation look-aside buffer, wherein each entry in the instruction translation look-aside buffer indicates whether an associated page of instruction includes entries in the control redirection table.

21. The computer system of claim 20, wherein each entry in the instruction translation look-aside buffer indicates whether all entries for a given page in the control redirection table have been entered in the control redirection buffer.

22. The computer system of claim 20, wherein the instruction fetch unit examines the instruction translation look-aside buffer and the control redirection buffer in parallel to determine whether to redirect the next instruction.

23. The computer system of claim 20, wherein each entry in the control redirection buffer includes a condition field, which indicates that the redirection is conditional upon a specific event taking place during execution of the original code.

24. The computer system of claim 18, wherein the transformed code can include:
code that is optimized to improve performance;
code that is instrumented for profiling; and
code that is transformed to facilitate debugging.

25. The computer system of claim 18, wherein redirection to the transformed code is accomplished without modifying the original code.

26. The computer system of claim 18, wherein redirections are persistent across context switches.
